(19) United States
(12) Patent Application Publication
(10) Pub. No.: US 2025/0095426 A1
(43) Pub. Date: Mar. 20, 2025

(54) SYSTEM, SERVER APPARATUS, CONTROL METHOD OF SERVER APPARATUS, AND STORAGE MEDIUM

(71) Applicant: NEC Corporation, Minato-ku, Tokyo (JP)

(72) Inventors: Masanori Kobayashi, Tokyo (JP); Takashi Yamamoto, Tokyo (JP); Keisuke Nemoto, Tokyo (JP); Tsubasa Ogikubo, Tokyo (JP)

(73) Assignee: NEC Corporation, Minato-ku, Tokyo (JP)

(21) Appl. No.: 18/729,236

(22) PCT Filed: Feb. 17, 2022
(86) PCT No.: PCT/JP2022/006306

§ 371 Date: Jul. 16, 2024

(51) Int. Cl. G07C 9/25; G07C 9/10

(52) U.S. Cl. CPC G07C 9/257; G07C 9/10

(57) ABSTRACT

A system includes a server apparatus and a first authentication terminal. The server apparatus stores ticket information including contents of a ticket purchased by a representative, the ticket permitting the representative and at least one or more accompanying persons to enter a first restricted admission area, and authentication information of the representative. When the representative and at least one or more accompanying persons enter the first restricted admission area, the first authentication terminal transmits a first authentication request that includes authentication information of the representative to the server apparatus. The server apparatus identifies the representative who attempts to enter the first restricted area by an authentication processing using the authentication information included in the authentication request and the stored authentication information. The server apparatus transmits the ticket information corresponding to the identified representative to the first authentication terminal. The first authentication terminal performs control in accordance with the ticket information.

### TECHNICAL FIELD

The present invention relates to a system, a server apparatus, a control method of a server apparatus, and a storage medium.

### BACKGROUND ART

There are technologies for authenticating ticket purchasers and for managing entry to facilities.

For example, Patent Literature 1 states that it is possible to reliably prevent fraudulent acts such as ticket counterfeiting and resale, and that entry processing can be performed speedily while using highly accurate biometric authentication. A ticketing management system of Patent Literature 1 includes a server apparatus, a user terminal, and a code reading device. The server includes a code issuing means that issues a unique code when biometric information previously registered by a user matches biometric information registered by the user before entering a venue. In addition, the server includes authentication means for authenticating that the user is a true ticket purchaser by reading the unique code displayed on the user terminal with the code reading device. Patent Literature 2 describes providing an entry management apparatus that prevents a decrease in convenience when a group of a plurality of people enters by adding a control to a function of a security gate that suppresses occurrence of waiting in line, without improving an authentication speed of a personal authentication device.

### CITATION LIST

### Patent Literature

[PTL 1] Japanese Unexamined Patent Application Publication No. JP2019-128694
[PTL 2] Japanese Unexamined Patent Application Publication No. JP2003-288625

### SUMMARY OF INVENTION

### Technical Problem

When entering a facility such as an amusement park, it is necessary to purchase a ticket. At that time, as described in Patent Literature 1, it is conceivable to purchase an electronic ticket and use biometric authentication for user authentication. Here, when a group of plurality of users (for example, a family) purchases tickets to enter a facility, it is a heavy burden on the ticket purchaser to register biometric information of each user.

It is a main object of the present invention to provide a system, a server apparatus, a control method of a server apparatus, and a storage medium that contribute to reducing burden on a user who purchases tickets to enter a facility with a plurality of persons.

### Solution to Problem

According to a first aspect of the present invention, there is provided a system, including: a server apparatus that stores ticket information including contents of a ticket purchased by a representative, the ticket permitting the representative and at least one or more accompanying persons to enter a first restricted admission area, and authentication information of the representative; and a first authentication terminal that transmits a first authentication request including the authentication information of the representative to the server apparatus when the representative and the at least one or more accompanying persons enter the first restricted admission area, wherein the server apparatus identifies the representative who attempts to enter the first restricted admission area by an authentication processing using the authentication information included in the authentication request and the stored authentication information, and transmits the ticket information corresponding to the identified representative to the first authentication terminal, and wherein the first authentication terminal performs control in accordance with the ticket information.

According to a second aspect of the present invention, there is provided a server apparatus, including: a storage unit that stores ticket information including contents of a ticket purchased by a representative, the ticket permitting the representative and at least one or more accompanying persons to enter a first restricted admission area, and authentication information of the representative; a receiving unit that receives, from a first authentication terminal, a first authentication request including the authentication information of the representative when the representative and the at least one or more accompanying persons enter the first restricted admission area; and an authentication unit that identifies the representative who attempts to enter the first restricted admission area by an authentication processing using the authentication information included in the authentication request and the stored authentication information, and transmits the ticket information corresponding to the identified representative to the first authentication terminal.

According to a third aspect of the present invention, there is provided a control method of a server apparatus, the control method including: storing ticket information including contents of a ticket purchased by a representative, the ticket permitting the representative and at least one or more accompanying persons to enter a first restricted admission area, and authentication information of the representative; receiving, from a first authentication terminal, a first authentication request including the authentication information of the representative when the representative and the at least one or more accompanying persons enter the first restricted admission area; and identifying the representative who attempts to enter the first restricted admission area by an authentication processing using the authentication information included in the authentication request and the stored authentication information, and transmitting the ticket information corresponding to the identified representative to the first authentication terminal.

According to a fourth aspect of the present invention, there is provided a computer-readable storage medium, storing a program that causes a computer mounted on a server apparatus to perform processing for: storing ticket information including contents of a ticket purchased by a representative, the ticket permitting the representative and at least one or more accompanying persons to enter a first restricted admission area, and authentication information of the representative; receiving, from a first authentication terminal, a first authentication request including the authentication information of the representative when the representative and the at least one or more accompanying persons enter the first restricted admission area; and identifying the representative who attempts to enter the first restricted admission area by an authentication processing using the authentication information included in the authentication request and the stored authentication information, and transmitting the ticket information corresponding to the identified representative to the first authentication terminal.

### Advantageous Effects of Invention

The individual aspects of the present invention provide a system, a server apparatus, a control method of a server apparatus, and a storage medium that contribute to reducing burden on a user who purchases tickets to enter a facility with a plurality of persons. The advantageous effect of the present invention is not limited to the above advantageous effect. The present invention may provide other advantageous effects, instead of or in addition to the above advantageous effect.

### BRIEF DESCRIPTION OF THE DRAWINGS

FIG. 1 is a diagram illustrating an outline of an example embodiment.

FIG. 2 is a flowchart illustrating an operation of an example embodiment.

FIG. 3 is a diagram illustrating an example of a schematic configuration of an information processing system according to a first example embodiment.

FIG. 4 is a diagram illustrating an operation of the information processing system according to the first example embodiment.

FIG. 5 is a diagram illustrating an operation of the information processing system according to the first example embodiment.

FIG. 6 is a diagram illustrating an example of a processing configuration of a server apparatus according to the first example embodiment.

FIG. 7 is a diagram illustrating an example of a display of a terminal according to the first example embodiment.

FIG. 8 is a diagram illustrating an example of a display of a terminal according to the first example embodiment.

FIG. 9 is a diagram illustrating an example of a ticket management database according to the first example embodiment.

FIG. 10 is a diagram illustrating an example of an operation of an authentication unit according to the first example embodiment.

FIG. 11 is a diagram illustrating an example of a processing configuration of an authentication terminal according to the first example embodiment.

FIG. 12 is a diagram illustrating an example of a display of the authentication terminal according to the first example embodiment.

FIGS. 13A and 13B are diagrams illustrating an example of a display of the authentication terminal according to the first example embodiment.

FIG. 14 is a sequence diagram illustrating an example of an operation of the information processing system according to the first example embodiment.

FIG. 15 is a diagram illustrating a configuration of an information processing system according to a second example embodiment.

FIG. 16 is a diagram illustrating an example of a display of a terminal according to the second example embodiment.

FIG. 17 is a diagram illustrating an example of a first ticket management database according to the second example embodiment.

FIG. 18 is a diagram illustrating an example of a display of the terminal according to the second example embodiment.

FIG. 19 is a diagram illustrating an example of a display of the terminal according to the second example embodiment.

FIG. 20 is a diagram illustrating an example of a second ticket management database according to the second example embodiment.

FIG. 21 is a diagram illustrating an example of a hardware configuration of a server apparatus of the present application.

FIG. 22 is a diagram illustrating an example of a display of an authentication terminal according to a variation of the present application.

### EXAMPLE EMBODIMENT

First, an outline of an example embodiment will be described. In the following outline, various components are denoted by reference characters for the sake of convenience. That is, the following reference characters are used as examples to facilitate the understanding of the present invention. Thus, the description of the outline is not intended to impose any limitations. In addition, unless otherwise specified, an individual block illustrated in the drawings represents a configuration of a functional unit, not a hardware unit. An individual connection line between blocks in the drawings signifies both one-way and two-way directions. An arrow schematically illustrates a principal signal (data) flow and does not exclude bidirectionality. In the present description and drawings, elements that can be described in a like way will be denoted by a like reference character, and redundant description thereof will be omitted as needed.

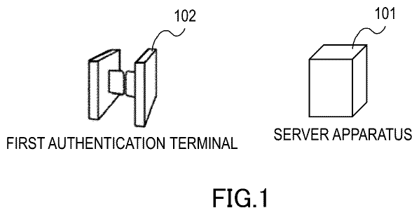

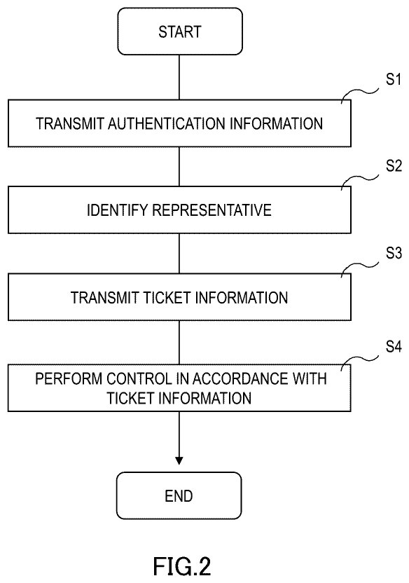

A system according to an example embodiment includes a server apparatus 101 and a first authentication terminal 102 (see FIG. 1). The server apparatus 101 stores ticket information including contents of a ticket purchased by a representative, the ticket permitting the representative and at least one or more accompanying persons to enter a first restricted admission area, and authentication information of the representative. When the representative and at least one or more accompanying persons enter the first restricted admission area, the first authentication terminal 102 transmits a first authentication request that includes authentication information of the representative to the server apparatus 101 (step S1 in FIG. 2). The server apparatus 101 identifies the representative who attempts to enter the first restricted area by an authentication processing using the authentication information included in the authentication request and the stored authentication information (step S2). The server apparatus 101 transmits the ticket information corresponding to the identified representative to the first authentication terminal 102 (step S3). The first authentication terminal 102 performs control in accordance with the ticket information (step S4).

In the above system, a representative of a group (for example, a parent) can purchase a ticket for the group to enter the restricted admission area (for example, an event venue). At that time, the server apparatus 101 stores the authentication information of the representative who has purchased the ticket in association with detailed authentication information of the purchased ticket with each other. The first authentication terminal 102 installed at an entrance of the restricted admission area transmits the authentication information of the representative who has purchased the ticket to the server apparatus 101 when the group (family) enters the restricted admission area. The server apparatus 101 identifies a person who attempts to enter based on the authentication information and transmits the details of the ticket (ticket information) purchased by the person who attempts to enter to the first authentication terminal 102. For example, the first authentication terminal 102 displays the received ticket information. Specifically, the first authentication terminal 102 displays the number of persons who can enter with the ticket that the representative has purchased. A staff member waiting at the entrance of the restricted admission area checks the display and permits the family including the representative to enter. In this way, the system of the present application reduces the burden on a user who purchases a ticket for a plurality of persons to enter a facility, because the system does not require authentication information for anyone other than the representative when the plurality of persons attempts to enter the facility.

Hereinafter, specific example embodiments will be described in more detail with reference to drawings.

### First Example Embodiment

A first example embodiment will be described in more detail with reference to drawings.

### System Configuration

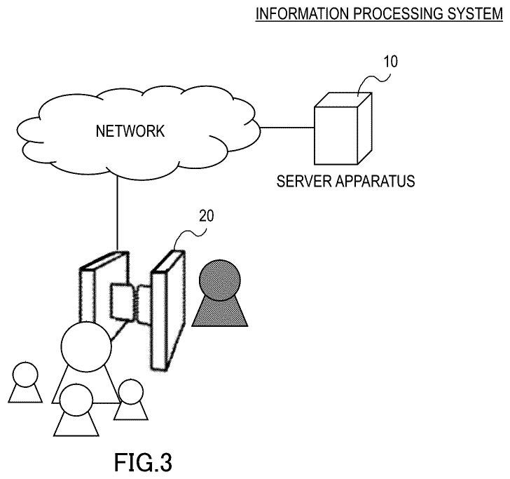

FIG. 3 is a diagram illustrating an example of a schematic configuration of an information processing system (authentication system, electronic ticket system) according to a first example embodiment. As shown in FIG. 3, the information processing system includes a server apparatus 10 and an authentication terminal 20.

The server apparatus 10 is managed and operated by a business operator, and so on that sells a ticket. An example of the ticket that the business operator sells is a ticket for transportation such as an airplane, train, or ship, or a ticket for an event such as a sporting event, concert, play, or movie. Alternatively, the ticket that the above business operator sells may be a ticket for entry to an amusement park, and so on, or a ticket for an attraction, and so on installed at the amusement park.

The server apparatus 10 is an apparatus that handles ticket sales and the like. The server apparatus 10 may be installed in the premises of the business operator that sells a ticket, or the server apparatus 10 may be installed on a network (on a cloud).

The authentication terminal 20 is, for example, an apparatus (a gate apparatus equipped with a gate) installed at an entrance to a restricted admission area where a user who do not possess a valid ticket is not permitted to enter. The authentication terminal 20 permits the user who possesses the valid ticket to pass through (enter the above-mentioned restricted admission area) and rejects the user who does not possess the valid ticket to pass through.

The apparatuses illustrated in FIG. 3 are connected to each other. Specifically, the server apparatus 10 and the authentication terminals 20 are connected by wired or wireless communication means and are configured to be able to communicate with each other.

The configuration of the information processing system shown in FIG. 3 is an example and is not intended to limit the configuration of the information processing system. For example, the information processing system may include a plurality of server apparatuses 10. Further, the information processing system may include at least one or more authentication terminals 20. Note that in the drawings, including Fig. 3, the authentication terminal 20 is shown as a gate apparatus that includes a gate, but the authentication terminal 20 can be any apparatus or device that includes a camera. For example, the authentication terminal 20 may be a kiosk terminal, tablet, or the like.

### Outline of Operation Next, a schematic operation of the information processing system according to the first example embodiment will be described.

### <Purchase of Ticket>

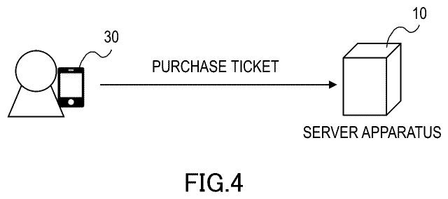

A user accesses the server apparatus 10 to purchase a ticket (see FIG. 4). For example, the user operates a terminal 30 to access a ticket sales site provided by the server apparatus 10.

The user operates the terminal 30 and purchases the ticket that the user intends to purchase. In addition, the user registers authentication information with the server apparatus 10 in order to pass through the authentication terminal 20 with the ticket that the user has purchased. Examples of the authentication information include biometric information of the user or an authentication code.

The biometric information is information required when undergoing biometric authentication at the authentication terminal 20.

Note that examples of the biometric information include data (feature values) calculated from physical features unique to an individual, such as a face, a fingerprint, a voiceprint, a vein, a retina, or an iris pattern of an eye. Alternatively, the biometric information may be image data such as a face image, a fingerprint image, and so on. The biometric information may be anything that includes physical characteristics of a user as information. In the present application, a case in which biometric information about a “face” of a person (a face image or a feature value generated from the face image) is used will be described.

The authentication code is information required when undergoing code authentication at the authentication terminal 20. For example, a terminal ID, and so on of the terminal 30 is an example of the authentication code.

Here, the user can purchase a ticket that allows others to enter a restricted admission area with the user. Specifically, a parent can purchase the ticket that allows both themselves and their child to enter the restricted admission area together. For example, the user purchases one ticket for an adult and three tickets for children. Note that it is at the discretion of each facility to determine how the ages of adults and children are set. For example, a user who is junior high school age or older is treated as an “adult” and a user who is elementary school age or younger is treated as a “child.

In the following descriptions, the user who purchases the ticket that allows themselves and another person to enter the restricted admission area will be described as a “representative”. Further, a user who can enter the restricted admission area together with the representative will be described as an “accompanying person”. In the above example, the parent corresponds to the “representative” and the three children correspond to the “accompanying persons”.

The server apparatus 10 stores authentication information of the representative and information regarding the purchased ticket (ticket information; for example, the number of persons permitted to enter) in association with each other in a ticket management database. Details of the ticket management database will be described below.

### <Use of Ticket>

The user who has purchased a ticket passes through the authentication terminal 20 and enters the restricted admission area. At that time, the user provides authentication information registered in advance to the authentication terminal 20.

When the representative and the accompanying person attempt to enter the restricted admission area, the authentication information registered in advance by the representative is provided to the authentication terminal 20. For example, when the representative has registered biometric information at the time of purchasing the ticket, the authentication terminal 20 acquires a face image of the representative (the parent in the above example). Alternatively, when the representative has registered an authentication code at the time of purchasing the ticket, the authentication terminal 20 acquires a terminal ID from the terminal 30 of the representative.

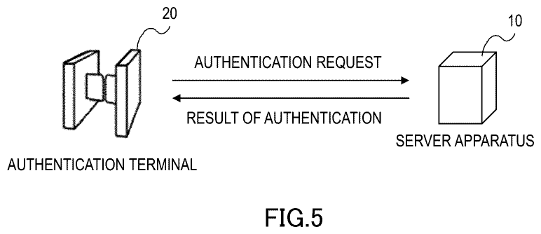

The authentication terminal 20 transmits an authentication request that includes the acquired authentication information (face image or terminal ID) to the server apparatus 10 (see FIG. 5).

The server apparatus 10 performs an authentication processing (biometric authentication, code authentication) using the authentication information that includes in the authentication request. When a person to be authenticated (a user who is about to pass through the authentication terminal 20) is identified by the authentication processing, the server apparatus 10 transmits ticket information of the ticket purchased by the identified person to be authenticated to the authentication terminal 20.

The authentication terminal 20 presents the received ticket information to a staff member (gray person shown in FIG. 3). For example, the authentication terminal 20 displays the ticket information on a liquid crystal display (not shown) or the like. In the above example, the authentication terminal 20 displays information such as “1 ticket for adult and 3 tickets for children”.

The staff member compares the content displayed on the authentication terminal 20 with the users (representative and accompanying person) waiting in line in front of the authentication terminal 20. When there is no difference between the users waiting in line in front of the authentication terminal 20 and the content displayed on the authentication terminal 20, the staff member opens the gate of the authentication terminal 20 and permits the users to pass through the gate in accordance with the content of the purchase ticket.

In the above example, when one adult and three children are waiting in line in front of the authentication terminal 20, the staff member permits these four persons to pass through the gate. After the staff member has confirmed that the four persons passed through the gate, the staff member closes the gate and prepares for a new user to enter the gate.

In this way, the server apparatus 10 stores ticket information that a representative has purchased and that includes the content of the ticket that allows the representative and at least one or more accompanying persons to enter a first restricted admission area, as well as the authentication information of the representative. When the representative and accompanying person attempt to enter the first restricted admission area, the authentication terminal 20 (a first authentication terminal) transmits a first authentication request that includes the authentication information of the representative to the server apparatus 10. The server apparatus 10 identifies the representative who attempts to enters the first restricted admission area by an authentication processing using the authentication information included in the authentication request and the stored authentication information. The server apparatus 10 transmits the ticket information corresponding to the identified representative to the authentication terminal 20. The authentication terminal 20 performs control in accordance with the ticket information.

For example, the authentication terminal 20 displays the number of persons who can enter the restricted admission area, which is listed in the ticket information. At that time, the authentication terminal 20 may display the number of persons for each attribute of the person who can enter the restricted admission area, which is listed in the ticket information. For example, the authentication terminal 20 may display the number of adults and children who can enter the restricted admission area.

Next, details of the individual apparatuses included in the information processing system according to the first example embodiment will be described.

### Server Apparatus

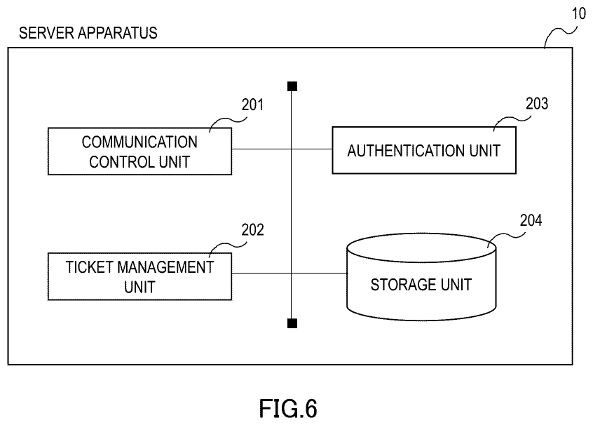

FIG. 6 is a diagram illustrating an example of a processing configuration (processing modules) of the server apparatus 10 according to the first example embodiment. Referring to FIG. 6, the server apparatus 10 includes a communication control unit 201, a ticket management unit 202, an authentication unit 203, and a storage unit 204.

The communication control unit 201 is means for controlling communication with other apparatuses. For example, the communication control unit 201 receives data (packets) from the authentication terminal 20. In addition, the communication control unit 201 transmits data to the authentication terminal 20. The communication control unit 201 gives data received from other apparatuses to other processing modules. The communication control unit 201 transmits data acquired from other processing modules to other apparatuses. In this way, other processing modules transmit and receive data to and from other apparatuses via the communication control unit 201. The communication control unit 201 includes a function as a receiving unit that receives data from other apparatuses and a function as a transmitting unit that transmits data to other apparatuses.

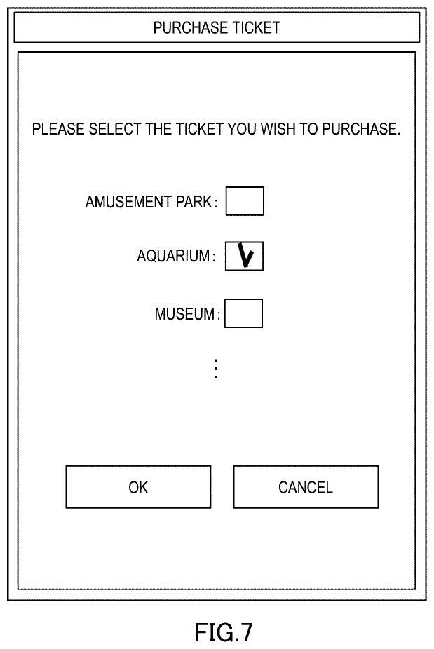

The ticket management unit 202 is means for controlling and managing tickets that users purchase. Specifically, when a user operates the terminal 30 and selects a predetermined menu (for example, ticket purchase menu) on the ticket purchase site, the ticket management unit 202 displays a list of tickets that can be purchased by the user (see FIG. 7).

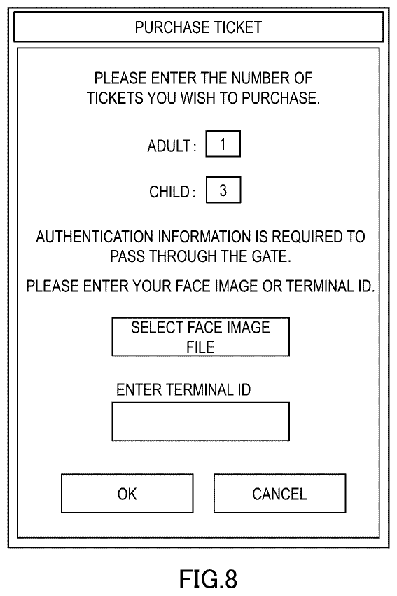

Once the type of ticket to be purchased is determined (when the OK button shown in FIG. 7 is pressed), the ticket management unit 202 acquires the type and number of tickets to be purchased (see FIG. 8). Furthermore, the ticket management unit 202 acquires authentication information to authenticate the ticket purchaser (representative).

For example, as shown in FIG. 8, the ticket management unit 202 acquires biometric information (face image) of the representative (ticket purchaser) or an authentication code (terminal ID). Alternatively, the ticket management unit 202 may acquire the biometric information and the authentication code, respectively.

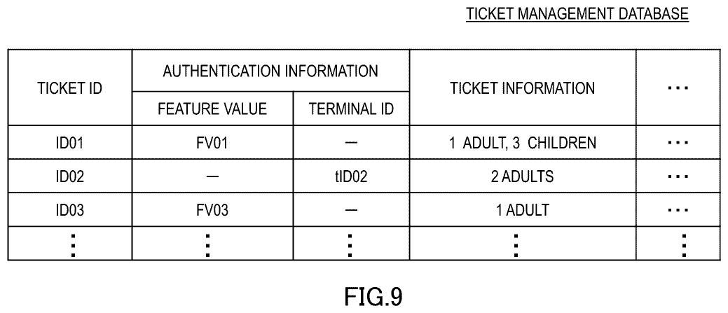

The ticket management unit 202 stores the acquired authentication information and information on the sold ticket (contents of the ticket; ticket information) in association with each other in the ticket management database (see FIG. 9). Note that when the ticket management unit 202 acquires a face image as the authentication information, the ticket management unit 202 generates a feature value from the face image and stores the generated feature value as the authentication information in the ticket management database.

Note that since an existing technology can be used to generate the feature values, a detailed description thereof will be omitted. For example, the ticket management unit 202 extracts eyes, nose, mouth, and so on as feature points from the face image. Next, the ticket management unit 202 calculates the location of an individual feature point and the distance between feature points as feature values and generates a feature vector formed by the plurality of feature values (vector information that characterizes the face image).

The authentication unit 203 is means for processing an authentication request that is received from the authentication terminal 20. The authentication unit 203 performs an authentication processing using the authentication information included in the authentication request and authentication information stored in the ticket management database.

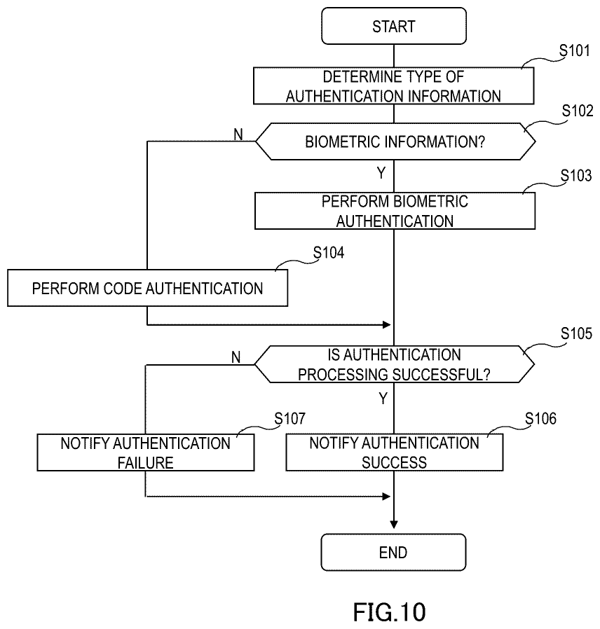

FIG. 10 is a flowchart illustrating an example of an operation of the authentication unit 203 according to the first example embodiment. Referring to FIG. 10, the operation of the authentication unit 203 will be described.

The authentication unit 203 determines a type of the authentication information included in the authentication request (step S101).

When the authentication information is biometric information (face image) (step S102, Yes branch), the authentication unit 203 performs biometric authentication (step S103). In this case, the authentication unit 203 performs a matching processing using the biometric information.

Specifically, the authentication unit 203 generates a feature value from the face image included in the authentication request. The authentication unit 203 sets the generated feature value as a target for matching and performs a matching processing between the feature value and the feature values registered in the ticket management database. More specifically, the authentication unit 203 sets the above generated feature value (feature vector) as the target of matching and performs 1-to-N matching (N is a positive integer, and the same applies to the following description) between the target for matching and a plurality of feature values registered in the ticket management database.

The authentication unit 203 calculates a similarity between the feature value to be matched and each of the plurality of feature values on the registration side. For the individual similarity, the chi-squared distance, the Euclidean distance, and so on may be used. A longer distance represents a lower similarity, and a shorter distance represents a higher similarity.

The authentication unit 203 determines that the biometric authentication has been successful when there exists a feature value whose similarity between the feature value among the plurality of feature values registered in the ticket management database and the feature value of the target to be matched is greater than a predetermined value. When the above feature value does not exist, the authentication unit 203 determines that the biometric authentication has failed.

When the authentication information is an authentication code (terminal ID) (step S102, No branch), the authentication unit 203 performs code authentication (step S104). In this case, the authentication unit 203 performs a matching processing using the authentication code.

The authentication unit 203 searches the ticket management database using the terminal ID included in the authentication request as a key. When the search is successful (when the same terminal ID is recorded), the authentication unit 203 determines that the code authentication has been successful. If the search fails (the same terminal ID is not recorded), the authentication unit 203 determines that code authentication has failed.

When the authentication processing (biometric authentication or code authentication) is successful (step S105, Yes branch), the authentication unit 203 notifies the authentication terminal 20 of the authentication success (step S106). At that time, the authentication unit 203 reads ticket information for the entry identified by the authentication processing (the entry with the highest similarity in case of biometric authentication) and transmits a positive response including the ticket information to the authentication terminal 20.

When the authentication processing (biometric authentication or code authentication) fails (step S105, No branch), the authentication unit 203 notifies the authentication terminal 20 of the authentication failure (step S107). The authentication unit 203 transmits a negative response indicating the authentication failure to the authentication terminal 20.

Note that when the authentication unit 203 notifies the authentication terminal 20 of the authentication success, the authentication unit 203 may delete the corresponding entry (entry in the ticket management database). The authentication unit 203 prevents the user (representative or accompanying person) from re-entering by deleting the entry. Alternatively, in a facility that permits re-entry, the authentication unit 203 deletes the above entry after the re-entry permission period (for example, on the day of ticket use) has elapsed.

The storage unit 204 is means for storing information necessary for an operation of the server apparatus 10. The ticket management database is established in the storage unit 204. The ticket management database stores the biometric information that is the authentication information of the representative or the authentication code.

### Authentication Terminal

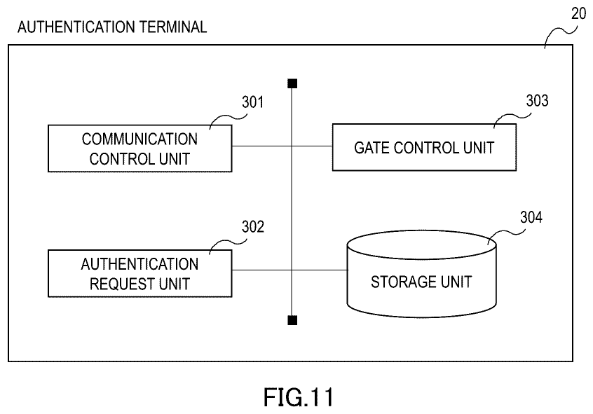

FIG. 11 is a diagram illustrating an example of a processing configuration (processing modules) of the authentication terminal 20 according to the first example embodiment. Referring to FIG. 11, the authentication terminal 20 includes a communication control unit 301, an authentication request unit 302, a gate control unit 303, and a storage unit 304.

The communication control unit 301 is means for controlling communication with other apparatuses. For example, the communication control unit 301 receives data (packets) from the server apparatus 10. In addition, the communication control unit 301 transmits data to the server apparatus 10. The communication control unit 301 gives data received from other apparatuses to other processing modules. The communication control unit 301 transmits data acquired from other processing modules to other apparatuses. In this way, other processing modules transmit and receive data to and from other apparatuses via the communication control unit 301. The communication control unit 301 includes a function as a receiving unit that receives data from other apparatuses and a function as a transmitting unit that transmits data to other apparatuses.

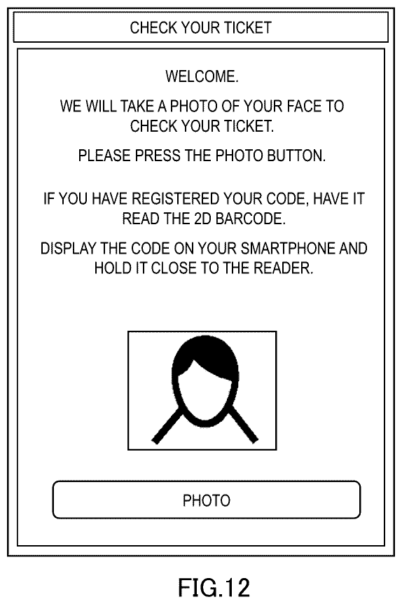

The authentication request unit 302 is means for requesting the server apparatus 10 to authenticate a user. The authentication request unit 302 acquires authentication information of the user. For example, the authentication request unit 302 displays a GUI as shown in FIG. 12 on a liquid crystal display (not shown) equipped with own apparatus, and acquires the same type of authentication information as the authentication information registered by the user at the time of purchasing the ticket.

When the user (representative) has registered biometric information (when the photo button in FIG. 12 has been pressed), the authentication request unit 302 controls a camera device (camera device included in the authentication terminal 20; not shown) and acquires a face image of the user.

When the user has registered a terminal ID as an authentication code (when a two-dimensional barcode has been read), the authentication request unit 302 decodes the read two-dimensional barcode and acquires the terminal ID.

Note that the user who has registered both the biometric information and the authentication code in the system selects one of them and provides the authentication information to the authentication terminal 20.

The authentication request unit 302 transmits an authentication request that includes the acquired authentication information (face image or terminal ID) to the server apparatus 10.

The authentication request unit 302 receives a response to the authentication request (result of authentication; positive response, negative response) from the server apparatus 10.

For example, the authentication request unit 302 displays a message or the like in accordance with the result of authentication on a display (not shown) that can be viewed by a staff member.

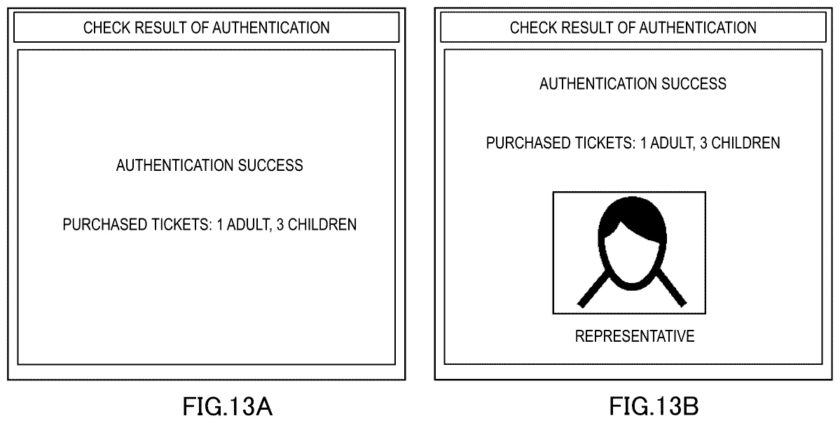

For example, when the authentication request unit 302 receives an authentication success (positive response), the authentication request unit 302 displays a message as shown in FIG. 13A. As shown in FIG. 13A, when the authentication is successful, the authentication request unit 302 displays the authentication success and the content of the ticket purchased by the user (representative).

Alternatively, when the authentication is successful, as shown in FIG. 13B, the authentication request unit 302 may display the face image of the representative in addition to the content of the ticket purchased by the representative. That is, when the authentication is successful, the authentication request unit 302 may display the face image transmitted to the server apparatus 10 along with the information of the purchased ticket.

When the authentication request unit 302 receives an authentication failure (negative response), the authentication request unit 302 displays a message to that effect.

The gate control unit 303 is means for controlling a gate included in the authentication terminal 20. Specifically, the gate control unit 303 controls the gate in accordance with an instruction from the staff member. For example, the gate control unit 303 opens or closes the gate in accordance with a status of a switch equipped with the authentication terminal 20.

The staff member waiting in the vicinity of the authentication terminal 20 opens and closes the gate while checking the displays shown in FIGS. 13A and 13B. For example, in the example in FIG. 13A, the staff member closes the gate after one adult and three children have passed through the gate.

The storage unit 304 is means for storing information necessary for an operation of the authentication terminal 20.

In this way, the authentication terminal 20 transmits to the server apparatus 10 an authentication request that includes biometric information of a representative who attempts to enter a restricted admission area. Alternatively, the authentication terminal 20 acquires an authentication code from the terminal possessed by the representative who attempts to enter the restricted admission area, and transmits the authentication request that includes the acquired authentication code to the server apparatus 10. The authentication terminal 20 performs a processing (for example, displaying ticket information) in accordance with a result of authentication acquired from the server apparatus 10.

### Terminal

Examples of the terminal 30 include a mobile terminal device such as a smartphone, a mobile phone, a game console, a tablet, and so on. The terminal 30 can be any equipment or device as long as the terminal 30 can accept an operation by a user and can communicate with the server apparatus 10, and so on. In addition, the terminal 30 needs to be able to convert the authentication code (terminal ID) stored internally into a two-dimensional barcode and display the two-dimensional barcode in response to an operation by the user. Note that the configuration, and so on, of the terminal 30 is obvious to those skilled in the art, so a detailed description will be omitted.

### System Operation

Next, operations of the information processing system according to the first example embodiment will be described.

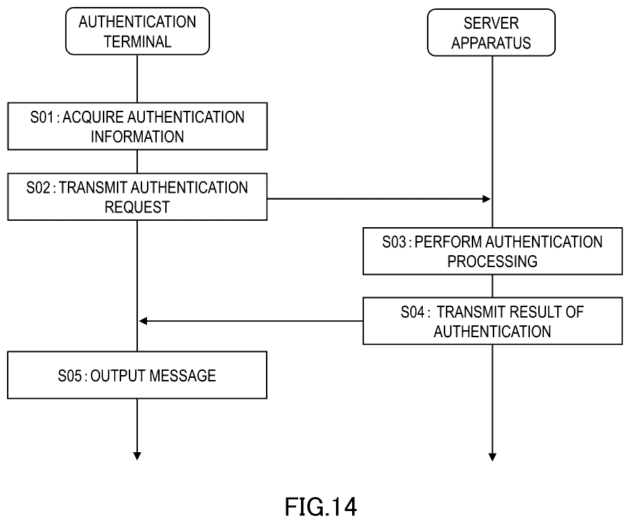

FIG. 14 is a sequence diagram illustrating an example of an operation in the information processing system according to the first example embodiment. Referring to FIG. 14, the operation when a user attempts to enter the restricted admission area will be described.

The authentication terminal 20 acquires authentication information from the user (representative) (Step S01).

The authentication terminal 20 transmits an authentication request that includes the authentication information to the server apparatus 10 (Step S02).

In response to receiving the authentication request, the server apparatus 10 performs an authentication processing (Step S03).

The server apparatus 10 transmits the result of authentication to the authentication terminal 20 (step S04). When the authentication is successful, the server apparatus 10 transmits ticket information of the ticket purchased by the user (representative) who has been identified by the authentication processing to the authentication terminal 20.

The authentication terminal 20 outputs a message or the like in accordance with the result of authentication (authentication success or authentication failure) (step S05). The staff member confirms the message and opens or closes the gate.

### <Variation According to the First Example Embodiment>

The above first example embodiment describes that the authentication terminal 20 presents the ticket information to a staff member waiting in a vicinity of own apparatus, and the staff member controls the opening and closing of the gate based on the presented information. However, the authentication terminal 20 may open and close the gate.

For example, the authentication terminal 20 may permit the number of users listed in the ticket information who can enter the restricted admission area to pass through the gate. In this case, the gate control unit 303 of the authentication terminal 20 permits the number of persons listed in the ticket information to pass through the gate. For example, the gate control unit 303 uses a human sensor or the like to ascertain the number of persons who pass through the gate, and closes the gate after the number of users listed in the ticket information has passed through the gate.

When it is necessary to distinguish between adults and children, the gate control unit 303 uses an infrared sensor or the like to ascertain the height of persons passing through the gate and permits the number of adults and the number of children listed in the ticket information to pass through.

As described above, the server apparatus 10 according to the first example embodiment sells a ticket to a representative of a group to enter a venue as the group. At that time, the server apparatus 10 stores authentication information of the representative who has purchased the ticket in association with detailed information of the purchased ticket with each other. When the group (family) attempts to enter the venue, the authentication terminal 20 transmits the authentication information of the representative who has purchased the ticket to the server apparatus 10. The server apparatus 10 identifies the person who attempts to enter based on the authentication information and transmits the detailed information (ticket information) of the ticket that the identified person who attempts to enter has purchased to the authentication terminal 20. When the authentication terminal 20 receives the ticket information, the authentication terminal 20 displays the number of persons who can enter with the ticket purchased by the representative. The staff member checks the display and permits the group (family) including the representative to enter. In this way, in the system according to the first example embodiment, when a plurality of persons attempts to enter the facility, authentication information other than that of the representative is not required, thus reducing the burden on the user who purchases a ticket to enter the facility with the plurality of persons.

In the first example embodiment, when the authentication of the representative is successfully authenticated, an accompanying person of the representative is also treated as having been successfully authenticated, and is permitted to enter the restricted admission area. As a result, in the information processing system according to the first example embodiment, the authentication processing of the accompanying person, which is normally required, becomes unnecessary, and the throughput of the entire system is improved. For example, in the above example, although an authentication processing for four parents and children is required, it is only necessary to perform an authentication processing for one representative, and the authentication processing can be completed quickly.

Furthermore, the staff member responsible for checking the ticket only has to check the result of authentication by the server apparatus 10 and control the gate without checking the validity of the ticket, thereby reducing the burden on the staff member. In other words, the staff member is only required to control the gate and does not need to check the validity of the ticket.

### Second Example Embodiment

Next, a second example embodiment will be described in detail with reference to drawings.

The first example embodiment describes ticket sales for entering one restricted admission area. A second example embodiment will describe ticket sales for a case in which an additional restricted admission area is included within one restricted admission area.

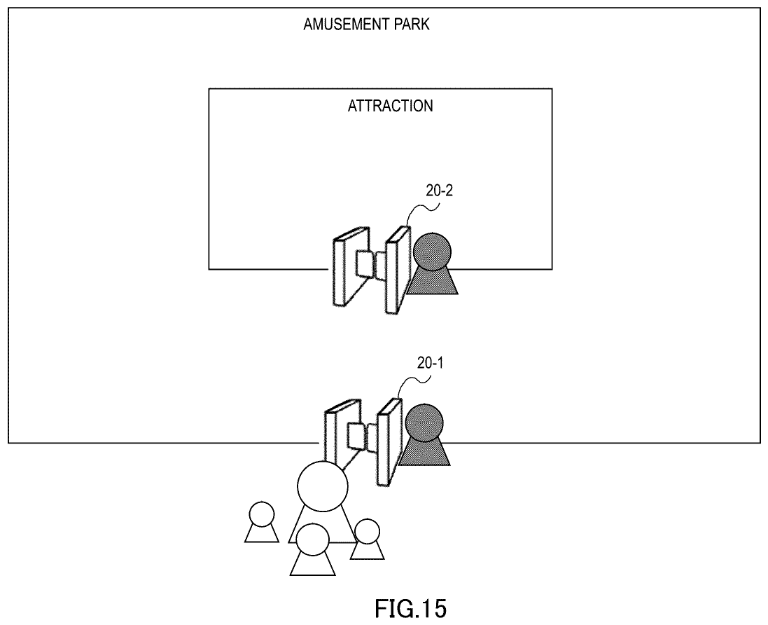

The second example embodiment will describe, for example, the ticket sales for a ticket to enter an amusement park and a ticket to use an attraction in the amusement park, as shown in FIG. 15.

As the information processing system according to the second example embodiment can have the same configuration as that according to the first example embodiment, the description corresponding to FIG. 3 will be omitted. In addition, as a processing configuration of a server apparatus 10 and an authentication terminal 20 according to the second example embodiment can have the same processing configurations as those according to the first and second example embodiments, description thereof will be omitted.

The following description will be made with a focus on the difference between the first example embodiment and the second example embodiment.

Note that the second example embodiment will describe a case in which biometric information (face image) is used as authentication information. However, as described in the first example embodiment, it is obvious that an authentication code (terminal ID) may also be used, or biometric information and the authentication code may be used together.

As shown in FIG. 15, the information processing system according to the second example embodiment includes an authentication terminal 20-1 and an authentication terminal 20-2. The second example embodiment will describe a case in which entry confirmation for the entire amusement park is performed by the authentication terminal 20-1, and entry confirmation for individual attractions is performed by the authentication terminal 20-2.

Further, the authentication terminal 20-1 requires authentication of each user (in the example of FIG. 15, 1 adult and 3 children), not only the representative. At that time, the authentication terminal 20-1 checks health condition of each user and permits a user with no health condition problems to pass through. Note that the check of the health condition of the user is performed by means of a vaccination certificate or a negative certificate related to an infectious disease. In the second example embodiment, the user who possesses a valid vaccination certificate (the user who has pre-registered a valid vaccination certificate) is determined to be the user with no health condition problems.

The server apparatus 10 identifies a person to be authenticated by authentication using authentication information (biometric information, authentication code) and reads health information (vaccination certificate, and so on) that is associated with the authentication information. The server apparatus 10 uses the health information (vaccination certificate, and so on) and determines whether the user is permitted to enter or not. The server apparatus 10 notifies the authentication terminal 20-1 of the result of determination.

The authentication terminal 20-2 also permits the accompanying person to enter by authenticating the representative, as described in the first example embodiment.

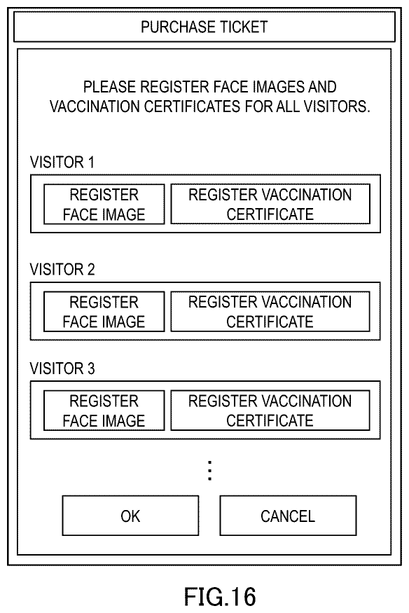

The ticket management unit 202 of the server apparatus 10 according to the second example embodiment displays a GUI as shown in FIG. 16 when purchasing a ticket for an amusement park is selected in a GUI as shown in FIG. 7. The ticket management unit 202 uses the GUI shown in FIG. 16 and acquires authentication information (face image) and a vaccination certificate for each person who attempts to enter the amusement park.

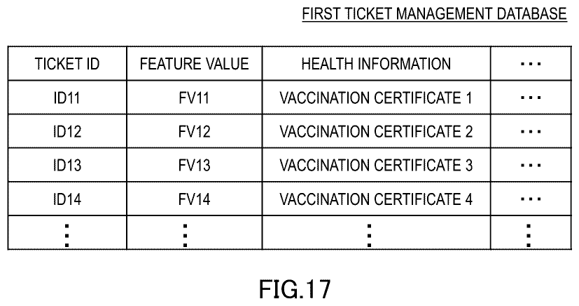

The ticket management unit 202 generates a feature value from the acquired face image and stores the feature value in association with health information (vaccination certificate) with each other. For example, the ticket management unit 202 stores the biometric information (feature values) and the health information (vaccination certificate) of each person who attempts to enter in association with each other in a first ticket management database, as shown in FIG. 17.

Note that in the above example, a parent registers his or her own face image (for example, an image file in which his or her face appears) and the vaccination certificate (an image file in which the vaccination certificate is captured) in the server apparatus 10. Furthermore, the parent registers a face image of his or her child and the vaccination certificate on behalf of the child in the server apparatus 10.

Furthermore, when the ticket management unit 202 registers the vaccination certificate, the ticket management unit 202 uses OCR (Optical Character Recognition) technology to read the content described on the vaccination certificate (for example, period of validity, and the like), and registers the content described on the vaccination certificate in the first ticket management database.

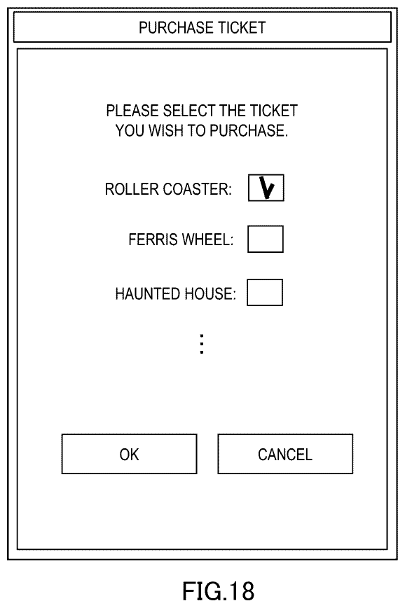

When the purchase of the ticket to enter the amusement park is completed (when the “OK” button shown in FIG. 16 is pressed), the ticket management unit 202 guides the user to purchase a ticket for the individual attractions. For example, the ticket management unit 202 displays a GUI as shown in FIG. 18.

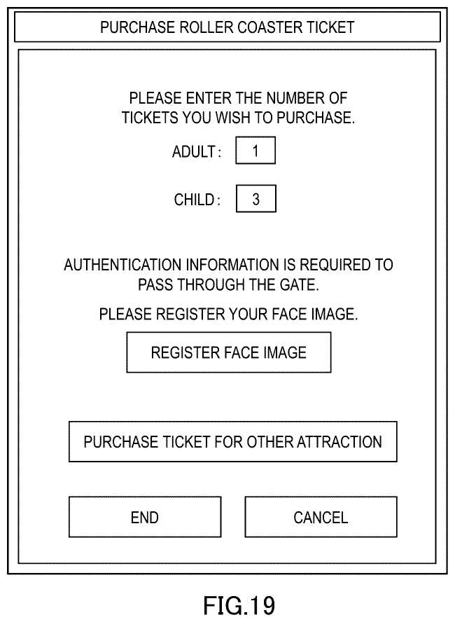

When the user selects an attraction, the ticket management unit 202 displays a GUI for purchasing a ticket for the attraction, as shown in FIG. 19. In this case, the ticket management unit 202 operates in the same manner as in the first example embodiment.

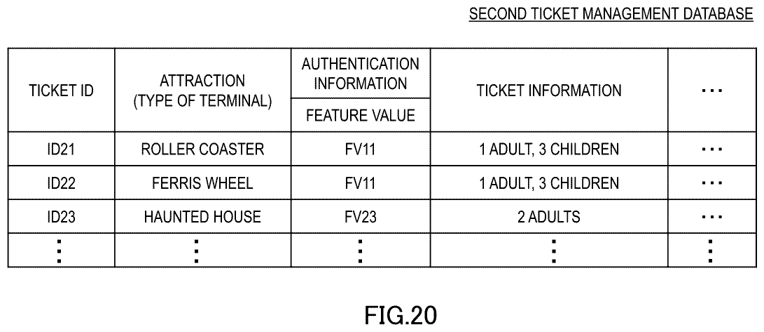

When the user (representative) registers authentication information (biometric information, face image) and completes the ticket purchase (when the “Purchase a ticket for another attraction” or “End” button shown in FIG. 19 is pressed), the ticket management unit 202 stores the authentication information and ticket information. For example, as shown in FIG. 20, the ticket management unit 202 registers a type of purchased attraction, the authentication information (feature values generated from face images) of the representative, and the ticket information in a second ticket management database.

Note that the same family member sometimes purchases tickets for different attractions. For example, FIG. 20 shows an example in which a representative (parent) with feature value “FV11” and his/her accompanying persons (three children) have purchased tickets for a “roller coaster” and a “Ferris wheel”.

The authentication request unit 302 of the authentication terminal 20-1 according to the second example embodiment acquires the authentication information of each user who wishes to enter a facility. In the example in FIG. 15, the authentication request unit 302 acquires the authentication information (face images) for each of one adult and three children, and transmits an authentication request to the server apparatus 10.

At that time, the authentication request unit 302 transmits the authentication request including a terminal type indicating an installation location of own terminal and the biometric information to the server apparatus 10. Specifically, the authentication request unit 302 transmits to the server apparatus 10 the authentication request that includes the terminal type “entrance” and the biometric information of the person to be authenticated.

Based on the terminal type, the authentication unit 203 of the server apparatus 10 grasps that the authentication request is from the authentication terminal 20-1 installed at the entrance of the amusement park. In this case, the authentication unit 203 processes the authentication request using the authentication information (biometric information) stored in the first ticket management database.

The authentication matching unit 203 performs a matching processing using the feature value generated from the face image included in the authentication request and feature values stored in the first ticket management database. If the matching processing fails, the authentication unit 203 transmits an authentication failure to the authentication terminal 20-1.

When the matching process is successful, the authentication matching unit 203 reads the health information (vaccination certificate) of the authenticated person to be authenticated who has been identified by the matching processing from the first ticket management database. The authentication unit 203 determines the validity of the read vaccination certificate. For example, the authentication unit 203 determines that the vaccination certificate is valid when the date and time of the authentication request processing is included in the validity period of the vaccination certificate.

When the vaccination certificate is valid, the authentication unit 203 notifies an authentication success to the authentication terminal 20-1. The authentication unit 203 transmits a positive response indicating the authentication success to the authentication terminal 20-1.

When the vaccination certificate is invalid (or when the vaccination certificate is not registered), the authentication unit 203 notifies an authentication failure to the authentication terminal 20-1. The authentication unit 203 transmits a negative response indicating the authentication failure to the authentication terminal 20-1.

The authentication request unit 302 of the authentication terminal 20-1 notifies the staff member of the result of authentication (authentication success or authentication failure). The staff member controls the gate in accordance with a display on the authentication terminal 20-1.

The authentication terminal 20-1 installed at the entrance of the amusement park and the server apparatus 10 repeat the above operation for each of the users. In the example in FIG. 15, the authentication is performed individually for each parent and the three children, and it is determined whether or not the parent and the three children are permitted to enter the amusement park.

The authentication request unit 302 of the authentication terminal 20-2 acquires authentication information of the representative as in the first example embodiment. The authentication request unit 302 transmits an authentication request that includes the acquired authentication information (face image) and a terminal type to the server apparatus 10.

The authentication unit 203 of the server apparatus 10 identifies the person to be authenticated based on the terminal type and the authentication information included in the authentication request. Specifically, the authentication unit 203 sets an entry for the same terminal type (attraction) as the terminal type included in the authentication request on the registration side and performs a matching processing. For example, in the example in FIG. 20, when a feature value that is substantially the same as the feature value “FV11” is included in the authentication request, one of the entries is identified based on the terminal type (roller coaster, Ferris wheel).

The authentication unit 203 notifies the authentication terminal 20-2 of the ticket information of the entry identified by the biometric authentication.

The authentication terminal 20-2 displays the ticket information notified by the server apparatus 10 in the same manner as in the first example embodiment.

As described above, the server apparatus 10 stores authentication information of a representative who can enter a second restricted admission area (for example, an attraction in an amusement park) and authentication information of an accompanying person who can enter the restricted admission area. When the representative attempts to enter the second restricted admission area, the authentication terminal 20-2 (a second authentication terminal) transmits a second authentication request that includes the authentication information of the representative to the server apparatus 10. When the accompanying person who attempts to enter the second restricted admission area, the authentication terminal 20-2 transmits a third authentication request that includes the authentication information of the accompanying person to the server apparatus 10. The server apparatus 10 performs an authentication processing in response to the second and third authentication requests, and transmits each of the results of the authentication processing to the authentication terminal 20-2. The authentication terminal 20-2 performs a processing in accordance with the results of the second and third authentication processing.

Furthermore, the server apparatus 10 stores the authentication information of the representative who can enter the second restricted admission area and first health information regarding his or her health in association with each other. Furthermore, the server apparatus 10 stores the authentication information of the accompanying person who can enter the second restricted admission area and second health information regarding his or her health in association with each other. The server apparatus 10 identifies the representative who attempts to enter the second restricted admission area by the authentication processing using the authentication information included in a second authentication request, and when the first health information of the identified representative is valid, the server apparatus 10 transmits an authentication success to the authentication terminal 20-2. Similarly, the server apparatus 10 identifies the accompanying person who attempts to enter the second restricted admission area by the authentication processing using the authentication information included in a third authentication request, and when the second health information of the identified accompanying person is valid, the server apparatus 10 transmits an authentication success to the authentication terminal 20-2.

In this way, in the second example embodiment, when health information or the like needs to be checked as a requirement to enter the amusement park, and so on, the authentication information and the health information (vaccination certificate) are individually registered in the server apparatus 10. In the above example, the face images and the health information of each parent and the three children are stored in association with each other. The second example embodiment can also mix locations where individual authentication is required, such as the entrance to the entire amusement park, with locations where only authentication by the representative is required, such as individual attractions. In other words, when health information or the like needs to be checked to enter an event venue, etc., authentication is performed individually. Moreover, when only the number of tickets needs to be checked, such as for an individual event, authentication may be performed only for the representative. In this way, different targets for authentication may be used when entering an entire facility and when entering individual areas. As a result, a facility administrator, or the like can flexibly operate the system in accordance with the characteristics of the facility, and so on.

In addition, it is sufficient that health information (for example, vaccination certificate) is checked once at the entrance of the facility, and it is not necessary to check the health information many times inside the facility. Therefore, in the second example embodiment, the authentication terminal 20-1 installed at the entrance of the facility acquires a face image of each person who attempts to enter and transmits the face image to the server apparatus 10. The server apparatus 10 checks the health information of each person who attempts to enter and determines whether or not the person can enter the facility. On the other hand, since health condition of each user of the attraction inside the facility has already been checked, it is sufficient that the number of tickets is checked by authentication of the representative.

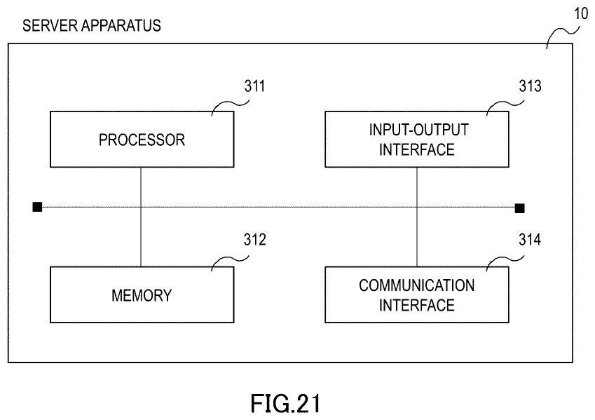

Next, a hardware configuration of an individual apparatus that constitutes the information processing system will be described. FIG. 21 is a diagram illustrating an example of a hardware configuration of the server apparatus 10.

The server apparatus 10 can be configured by an information processing apparatus (a so-called computer) and has a configuration illustrated as an example in FIG. 21. For example, the server apparatus 10 includes a processor 311, a memory 312, an input-output interface 313, a communication interface 314, and so on. The components such as the processor 311 are connected to an internal bus, and so on so that these components can communicate with each other.

The hardware configuration of the server apparatus 10 is not limited to the configuration illustrated in FIG. 21. The server apparatus 10 may include hardware not illustrated or may be configured without the input-output interface 313 if desired. In addition, the number of components, such as the number of processors 311, included in the server apparatus 10 is not limited to the example illustrated in FIG. 21. For example, a plurality of processors 311 may be included in the server apparatus 10.

For example, the processor 311 is a programmable device such as a CPU (Central Processing Unit), an MPU (Micro Processing Unit), or a DSP (Digital Signal Processor). Alternatively, the processor 311 may be a device such as an FPGA (Field Programmable Gate Array) or an ASIC (Application Specific Integrated Circuit). The processor 311 executes various kinds of programs including an operating system (OS).

The memory 312 is a RAM (Random Access Memory), a ROM (Read-Only Memory), an HDD (Hard Disk Drive), an SSD (Solid State Drive), and so on. The memory 312 stores an OS program, an application program, and various kinds of data.

The input-output interface 313 is an interface for a display apparatus and an input apparatus not illustrated. For example, the display apparatus is a liquid crystal display and so on. For example, the input apparatus is an apparatus that receives user operations, and examples of the input apparatus include a keyboard and a mouse.

The communication interface 314 is a circuit, a module, and so on for performing communication with other apparatuses. For example, the communication interface 314 includes a NIC (Network Interface Card) and so on.

The functions of the server apparatus 10 are realized by various kinds of processing modules. The processing modules are realized, for example, by causing the processor 311 to execute a program stored in the memory 312. In addition, this program can be recorded in a computer-readable storage medium. The storage medium may be a non-transient (non-transitory) storage medium, such as a semiconductor memory, a hard disk, a magnetic recording medium, or an optical recording medium. That is, the present invention can be embodied as a computer program product. In addition, the above program may be updated by downloading a program via a network or by using a storage medium in which a program is stored. In addition, the above processing modules may be realized by semiconductor chips.

As is the case with the authentication terminal 20 can be configured by an information processing apparatus, and the basic hardware configuration of the authentication terminal 20 is the same as that of the server apparatus 10. Thus, description of the basic hardware configuration of the authentication terminal 20 will be omitted. For example, the authentication terminal 20 may include a camera device for photographing a person to be authenticated or a gate apparatus.

The server apparatus 10 which is an information processing device includes a computer and can realize its functions by causing the computer to execute a program. In addition, the server apparatus 10 executes a control method of the server apparatus 10 by using this program. Similarly, the authentication terminal 20 includes a computer, and the functions of the authentication terminal 20 can be realized by causing the computer to execute a program. In addition, the authentication terminal 20 executes a control method of the authentication terminal 20 by using the program.

### Variations

The configurations, operations, and so on of the information processing system according to the above example embodiments are examples and do not limit the present system configuration, and so on.

The above example embodiments describe a case where the accompanying person are children, but it is obvious that the accompanying person may be adults.

Furthermore, a user who pays for a ticket does not have to be the representative. For example, even if the parent purchases the ticket, a face image of the child may be registered as biometric information for the representative. In other words, the representative need only be a person who is authenticated on behalf of a group.

The above example embodiments describe that a ticket is sold by distinguishing between adults and children. However, the ticket may be sold by distinguishing between genders. That is, the ticket information may include contents such as “1 ticket for men and 3 tickets for women” or contents such as “1 ticket for adult men, and 3 tickets for child women.”

The above example embodiments describe a case where the authentication terminal 20 acquires the authentication information that the representative has registered in the system when authenticating the representative (see FIG. 12). Here, the authentication terminal 20 may acquire biometric information in priority, and may acquire an authentication code when the authentication terminal 20 fails to authenticate using the biometric information. In this case, the authentication terminal 20 acquires biometric information (face image) of the user standing in front of own terminal. The authentication terminal 20 transmits an authentication request including the biometric information to the server apparatus 10 and receives a response. When the authentication terminal 20 receives a negative response (authentication failure), the authentication terminal 20 displays a message to acquire the authentication code.

The above example embodiments describe a case in which the authentication terminal 20 displays ticket information on a liquid crystal display, or the like, of own terminal. Here, the server apparatus 10 may transmit the above ticket information to a terminal (for example, a tablet) held by a staff member. The staff member may control a gate based on a result displayed on the tablet. In other words, the server apparatus 10 may transmit the result of authentication for the authentication request received from the authentication terminal 20 to the terminal held by the staff member, instead of or in addition to the authentication terminal 20.

The above example embodiments describe that a terminal ID of the terminal 30 is used as an authentication code. However, the authentication code can be any information, not limited to the terminal ID. Further, instead of the user inputting the authentication code, the server apparatus 10 may generate the authentication code and transmit a two-dimensional barcode converted from the generated authentication code to the terminal 30. In this case, the server apparatus 10 treats a ticket ID of a ticket purchased by the user (representative) or a hash value of the ticket ID, and so on, as an authentication code, and registers the authentication code in the ticket management database. The server apparatus 10 converts the authentication code into the two-dimensional barcode and transmits the two-dimensional barcode to the terminal 30. When the user attempts to enter an event venue, or the like, the user displays the two-dimensional barcode acquired from the server apparatus 10 by operating the terminal 30. The server apparatus 10 may acquire the two-dimensional barcode and identify the user using the acquired two-dimensional barcode.

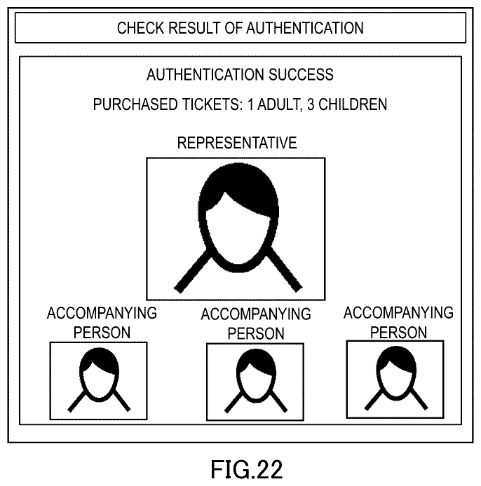

Here, as described in the second example embodiment, when an additional restricted admission area is included within one restricted admission area, authentication information of the representative and authentication information of the accompanying person may be stored in association with each other. For example, in the above example, the server apparatus 10 may store a face image of the representative, the parent, and face images of the accompanying persons, the three children, in association with each other. Furthermore, when the representative has been successfully authenticated in a restricted admission area (attraction) included in a restricted admission area (for example, the entire amusement park), the server apparatus 10 may transmit to the authentication terminal 20-2 the face image of the accompanying person stored in association with each other the above-mentioned representative. The authentication terminal 20-2 may display the face image of the representative and the face image of the accompanying person in addition to the content of the ticket purchased by the representative (see FIG. 22). In this way, since the authentication terminal 20-2 displays a list of the face images of the representative and the accompanying person, the staff member can securely check the accompanying person and control the gate (open and close the gate).

The above example embodiment describes a case in which a ticket management database is configured inside the server apparatus 10, but the database may be established in an external database server or the like. That is, some of the functions of the server apparatus 10 may be implemented in another server. More specifically, the “ticket management unit (ticket management means)”, “authentication unit (authentication means)”, and so on described above may be implemented in any device included in that includes the system.

While the data exchange between each apparatus (the server apparatus 10 and the authentication terminal 20) is not limited to any particular mode, data exchanged between these apparatuses may be encrypted. It is desirable that the biometric information and so on are transmitted and received between these apparatuses and encrypted data is transmitted and received in order to properly protect this information.

In the flowcharts and sequence diagrams used in the above description, a plurality of steps (processes) are sequentially described. However, the order of the execution of the steps performed in the individual example embodiment is not limited to the described order. In the individual example embodiment, the order of the illustrated steps may be changed to the extent that a problem is not caused on the content of the individual example embodiment. For example, individual processes may be executed in parallel.

The above example embodiments have been described in detail to facilitate the understanding of the present application disclosed and not to mean that all the configurations described above are needed. In addition, if a plurality of example embodiments have been described, each of the example embodiments may be used individually or a plurality of example embodiments may be used in combination. For example, part of a configuration according to one example embodiment may be replaced by a configuration according to another example embodiment. For example, a configuration according to one example embodiment may be added to a configuration according to another example embodiment. In addition, addition, deletion, or replacement is possible between part of a configuration according to one example embodiment and another configuration.

The industrial applicability of the present invention has been made apparent by the above description. That is, the present invention is suitably applicable, for example, to information processing systems that sell tickets to users.

A part or the entirety of the example embodiments described above may be described as in the following supplementary notes, but is not limited to the followings.

### Supplementary Note 1

A system, including:
a server apparatus that stores ticket information including contents of a ticket purchased by a representative, the ticket permitting the representative and at least one or more accompanying persons to enter a first restricted admission area, and authentication information of the representative; and
a first authentication terminal that transmits a first authentication request including the authentication information of the representative to the server apparatus when the representative and the at least one or more accompanying persons enter the first restricted admission area, wherein the server apparatus identifies the representative who attempts to enter the first restricted admission area by an authentication processing using the authentication information included in the authentication request and the stored authentication information, and transmits the ticket information corresponding to the identified representative to the first authentication terminal, and wherein the first authentication terminal performs control in accordance with the ticket information.

### Supplementary Note 2

The system according to supplementary note 1, wherein the first authentication terminal displays a number of persons who can enter the first restricted admission area, as listed in the ticket information.

### Supplementary Note 3

The system according to supplementary note 1 or 2, wherein the first authentication terminal displays a number of persons for each attribute of the person who can enter the first restricted admission area, as listed in the ticket information.

### Supplementary Note 4

The system according to any one of supplementary notes 1 to 3, wherein the first authentication terminal permits a number of users listed in the ticket information who can enter the first restricted admission area to pass through a gate.

### Supplementary Note 5

The system according to any one of supplementary notes 1 to 4, wherein the server apparatus stores biometric information as the authentication information of the representative, and
wherein the first authentication terminal transmits to the server apparatus the first authentication request including the biometric information of the representative who attempts to enter the first restricted admission area.

### Supplementary Note 6

The system according to supplementary note 5, wherein the biometric information is a face image or a feature value generated from the face image.

### Supplementary Note 7

The system according to any one of supplementary notes 1 to 4, wherein the server apparatus stores an authentication code as the authentication information of the representative, and
wherein the first authentication terminal acquires the authentication code from a terminal possessed by the representative who attempts to enter the first restricted admission area, and transmits the first authentication request including the acquired authentication code to the server apparatus.

### Supplementary Note 8

The system according to supplementary note 7, wherein the authentication code is a terminal ID of the terminal.

### Supplementary Note 9

The system according to any one of supplementary notes 1 to 8, wherein the server apparatus stores the authentication information of the representative who can enter a second restricted admission area and the authentication information of the at least one or more accompanying persons who can enter the second restricted admission area, and
wherein the system further includes a second authentication terminal that transmits a second authentication request including the authentication information of the representative to the server apparatus when the representative attempts to enter the second restricted admission area, and transmits a third authentication request including the authentication information of the at least one or more accompanying persons to the server apparatus when the at least one or more accompanying persons attempt to enter the second restricted admission area, and
wherein the server apparatus performs the authentication processing in response to the second and third authentication requests, and transmits each of results of the authentication processing to the second authentication terminal, and
wherein the second authentication terminal performs a processing in accordance with the results of the second and third authentication processing.

### Supplementary Note 10

The system according to supplementary note 9, wherein the server apparatus stores the authentication information of the representative who can enter the second restricted admission area and first health information regarding health in association with each other, and stores the authentication information of the at least one or more accompanying persons who can enter the second restricted admission area and second health information regarding health in association with each other, and wherein the server apparatus identifies the representative who attempts to enter the second restricted admission area by the authentication processing using the authentication information included in the second authentication request, and transmits an authentication success to the second authentication terminal when the first health information of the identified representative is valid, and
wherein the server apparatus identifies the at least one or more accompanying persons who attempt to enter the second restricted admission area by the authentication processing using the authentication information included in the third authentication request, and transmits an authentication success to the second authentication terminal when the second health information of the identified accompanying person is valid.

### Supplementary Note 11

The system according to supplementary note 10, wherein the first and second health information are a vaccination certificate or a negative certificate.

### Supplementary Note 12

A server apparatus, including:
a storage unit that stores ticket information including contents of a ticket purchased by a representative, the ticket permitting the representative and at least one or more accompanying persons to enter a first restricted admission area, and authentication information of the representative;
a receiving unit that receives, from a first authentication terminal, a first authentication request including the authentication information of the representative when the representative and the at least one or more accompanying persons enter the first restricted admission area; and an authentication unit that identifies the representative who attempts to enter the first restricted admission area by an authentication processing using the authentication information included in the authentication request and the stored authentication information, and transmits the ticket information corresponding to the identified representative to the first authentication terminal.

### Supplementary Note 13

A control method of a server apparatus, the control method including: storing ticket information including contents of a ticket purchased by a representative, the ticket permitting the representative and at least one or more accompanying persons to enter a first restricted admission area, and authentication information of the representative;
receiving, from a first authentication terminal, a first authentication request including the authentication information of the representative when the representative and the at least one or more accompanying persons enter the first restricted admission area; and
identifying the representative who attempts to enter the first restricted admission area by an authentication processing using the authentication information included in the authentication request and the stored authentication information, and transmitting the ticket information corresponding to the identified representative to the first authentication terminal.

### Supplementary Note 14

A computer-readable storage medium, storing a program that causes a computer mounted on a server apparatus to perform processing for: storing ticket information including contents of a ticket purchased by a representative, the ticket permitting the representative and at least one or more accompanying persons to enter a first restricted admission area, and authentication information of the representative;
receiving, from a first authentication terminal, a first authentication request including the authentication information of the representative when the representative and the at least one or more accompanying persons enter the first restricted admission area; and
identifying the representative who attempts to enter the first restricted admission area by an authentication processing using the authentication information included in the authentication request and the stored authentication information, and transmitting the ticket information corresponding to the identified representative to the first authentication terminal.

The entire disclosure of the above patent literature is incorporated herein by reference thereto. While the example embodiments of the present invention have thus been described, the present invention is not limited to these example embodiments. It is to be understood to those skilled in the art that these example embodiments are only examples and that various variations are possible without departing from the scope and sprit of the present invention. That is, the present invention of course includes various variations and modifications that could be made by those skilled in the art in accordance with the overall disclosure including the claims and the technical concept.

### Reference Signs List

10 server apparatus
20 authentication terminal
20-1 authentication terminal
20-2 authentication terminal
30 terminal
101 server apparatus
102 first authentication terminal
201 communication control unit
202 ticket management unit
203 authentication unit
204 storage unit
301 communication control unit
302 authentication request unit
303 gate control unit
304 storage unit
311 processor
312 memory

What is claimed is:

1. A system, comprising:
a server apparatus that stores ticket information including contents of a ticket purchased by a representative, the ticket permitting the representative and at least one or more accompanying persons to enter a first restricted admission area, and authentication information of the representative; and
a first authentication terminal that transmits a first authentication request including the authentication information of the representative to the server apparatus when the representative and the at least one or more accompanying persons enter the first restricted admission area,
wherein the server apparatus identifies the representative who attempts to enter the first restricted admission area by an authentication processing using the authentication information included in the authentication request and the stored authentication information, and transmits the ticket information corresponding to the identified representative to the first authentication terminal, and
wherein the first authentication terminal performs control in accordance with the ticket information.

2. The system according to claim 1, wherein the first authentication terminal displays a number of persons who can enter the first restricted admission area, as listed in the ticket information.

3. The system according to claim 1, wherein the first authentication terminal displays a number of persons for each attribute of the person who can enter the first restricted admission area, as listed in the ticket information.

4. The system according to claim 1, wherein the first authentication terminal permits a number of users listed in the ticket information who can enter the first restricted admission area to pass through a gate.

5. The system according to claim 1, wherein the server apparatus stores biometric information as the authentication information of the representative, and
wherein the first authentication terminal transmits to the server apparatus the first authentication request including the biometric information of the representative who attempts to enter the first restricted admission area.

6. The system according to claim 5, wherein the biometric information is a face image or a feature value generated from the face image.

7. The system according to claim 1, wherein the server apparatus stores an authentication code as the authentication information of the representative, and
wherein the first authentication terminal acquires the authentication code from a terminal possessed by the representative who attempts to enter the first restricted admission area, and transmits the first authentication request including the acquired authentication code to the server apparatus.

8. The system according to claim 7, wherein the authentication code is a terminal ID of the terminal.

9. The system according to claim 1, wherein the server apparatus stores the authentication information of the representative who can enter a second restricted admission area and the authentication information of the at least one or more accompanying persons who can enter the second restricted admission area, and
wherein the system further comprises a second authentication terminal that transmits a second authentication request including the authentication information of the representative to the server apparatus when the representative attempts to enter the second restricted admission area, and transmits a third authentication request including the authentication information of the at least one or more accompanying persons to the server apparatus when the at least one or more accompanying persons attempt to enter the second restricted admission area, and
wherein the server apparatus performs the authentication processing in response to the second and third authentication requests, and transmits each of results of the authentication processing to the second authentication terminal, and
wherein the second authentication terminal performs a processing in accordance with the results of the second and third authentication processing.

10. The system according to claim 9, wherein the server apparatus stores the authentication information of the representative who can enter the second restricted admission area and first health information regarding health in association with each other, and stores the authentication information of the at least one or more accompanying persons who can enter the second restricted admission area and second health information regarding health in association with each other, and
wherein the server apparatus identifies the representative who attempts to enter the second restricted admission area by the authentication processing using the authentication information included in the second authentication request, and transmits an authentication success to the second authentication terminal when the first health information of the identified representative is valid, and
wherein the server apparatus identifies the at least one or more accompanying persons who attempt to enter the second restricted admission area by the authentication processing using the authentication information included in the third authentication request, and transmits an authentication success to the second authentication terminal when the second health information of the identified accompanying person is valid.

11. The system according to claim 10, wherein the first and second health information are a vaccination certificate or a negative certificate.

12. A server apparatus, comprising:
at least one memory storing a set of instructions; and
at least one processor configured to execute the set of instructions to:
store ticket information including contents of a ticket purchased by a representative, the ticket permitting the representative and at least one or more accompanying persons to enter a first restricted admission area, and authentication information of the representative;
receive, from a first authentication terminal, a first authentication request including the authentication information of the representative when the representative and the at least one or more accompanying persons enter the first restricted admission area; and
identify the representative who attempts to enter the first restricted admission area by an authentication processing using the authentication information included in the authentication request and the stored authentication information, and transmits the ticket information corresponding to the identified representative to the first authentication terminal.

13. A control method of a server apparatus, the control method comprising:
storing ticket information including contents of a ticket purchased by a representative, the ticket permitting the representative and at least one or more accompanying persons to enter a first restricted admission area, and authentication information of the representative;
receiving, from a first authentication terminal, a first authentication request including the authentication information of the representative when the representative and the at least one or more accompanying persons enter the first restricted admission area; and
identifying the representative who attempts to enter the first restricted admission area by an authentication processing using the authentication information included in the authentication request and the stored authentication information, and transmitting the ticket information corresponding to the identified representative to the first authentication terminal.

14. (canceled)
